(19) United States
(12) Patent Application Publication
(10) Pub. No.: US 2005/0196055 A1
(43) Pub. Date: Sep. 8, 2005

(54) Method and system for codifying signals that ensure high fidelity reconstruction

(76) Inventors: Sheng Zhong, San Jose, CA (US); Alexander G. MacInnis, Lake Oswego, OR (US)

Correspondence Address: MCANDREWS HELD & MALLOY, LTD, 500 WEST MADISON STREET, SUITE 3400, CHICAGO, IL, 60661, US

(21) Appl. No.: 11/073,306

(22) Filed: Mar. 3, 2005

Related U.S. Application Data
(60) Provisional application No. 60/550,244, filed on Mar. 4, 2004.

(51) Int. Cl. G06K 9/36; G06K 9/46

(52) U.S. Cl. 382/233; 382/250

(57) ABSTRACT

In a data processing system, a method and system for codifying signals that ensure high fidelity reconstruction are provided. A minimum number of most significant bits (MSBs) may be determined for use in a two-dimensional (2D) transform matrix during forward and inverse transform operations so that high fidelity reconstruction may be possible without the need for mismatch error control. For a forward transform operation, a minimum number of F MSBs may be selected from a reference transform coefficient in an effective transform matrix to ensure high fidelity reconstruction. For an inverse transform operation, a minimum number of R MSBs may be selected from the reference transform coefficient in the effective transform matrix to ensure high fidelity reconstruction. The effective transform matrix may result from the decomposition and implementation of a finite precision transform matrix. At least one dimension of the transform matrix may comprise four or eight points.

### CROSS-REFERENCE TO RELATED APPLICATIONS/INCORPORATION BY REFERENCE

This patent application makes reference to, claims priority to and claims benefit from U.S. Provisional Patent Application Ser. No. 60/550,244 filed on Mar. 4, 2004.

The above stated application is hereby incorporated herein by reference in its entirety.

### FIELD OF THE INVENTION

Certain embodiments of the invention relate to the processing of signals. More specifically, certain embodiments of the invention relate to a method and system for codifying signals that ensure high fidelity reconstruction.

### BACKGROUND OF THE INVENTION

In signal processing systems, the ability to efficiently and accurately reconstruct encoded or compressed data may generally depend on the compatibility of the encoding process and the decoding process. When the encoding and decoding are provided by different systems, for example, when systems from different vendors are utilized, mismatches may occur and the decoding system may have to correct these mismatches by providing additional hardware and/or software resources. Without these additional resources present in the decoding system, the mismatches that may occur may not be correctable and the reconstruction fidelity may significantly degrade.

In video systems, for example, where various implementations of the discrete cosine transform (DCT) and the inverse discrete cosine transform (IDCT) have been used for compression and decompression in a variety of video coding formats, mismatches tend to reduce image quality and may require significant computational complexity to correct. Since a wide range of vendors and/or implementations exist in video systems, mismatch compensation or mismatch correction may generally become a difficult issue to solve. In this regard, several standardization efforts have been initiated to address this concern.

One of the variations of the DCT/IDCT transform pair is in the form of an integer transform. The integer transform usually has the property of an exact inverse relationship between the DCT and IDCT by providing strict constraints on the integer values to be used in implementations. This approach, however, limits that ability of system designers to utilize architectures of different precision that may provide additional benefits to the overall design. A more traditional way of implementing the DCT/IDCT transform pair in video coding applications is by specifying the transform statistically and then utilizing sample data streams to test whether the implementation meets certain specified requirements. However, while different implementations may statistically fall within the specified requirements for a chosen set of sample data streams, these implementations may still produce significant mismatch errors when used in coding/decoding systems. Moreover, the chosen set of sample data streams may not provide sufficient coverage of the specified requirements to guarantee mismatch-free implementation.

The same considerations may extend to any implementation of forward/inverse transform pairs that may be utilized to perform coding/decoding operations. When transform pairs are implemented using strict constraints, high fidelity reconstruction may be achieved but design flexibility may be significantly limited. On the other hand, when transform pairs are implemented based on statistical requirements, flexible systems may be constructed but mismatch error control operations may still be needed.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method for codifying signals that ensure high fidelity reconstruction, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of a data coding and decoding system that may be utilized in connection with an embodiment of the invention.

FIG. 2 is a flow chart illustrating exemplary steps for determining a minimum number of most significant bits to be selected from a reference transform coefficient in an effective transform matrix, in accordance with an embodiment of the invention.

FIG. 3A is a flow chart illustrating exemplary steps that may be utilized to perform forward transform operations based on a minimum number of F MSBs for the transform coefficients in the transform matrix, in accordance with an embodiment of the invention.

FIG. 3B is a flow chart illustrating exemplary steps that may be utilized to perform inverse transform operations based on a minimum number of R MSBs for the transform coefficients in the transform matrix, in accordance with an embodiment of the invention.

FIG. 4A is a flow chart illustrating exemplary steps that may be utilized during an M×N DCT operation based on a minimum number of F MSBs for the transform coefficients in the transform matrix, in accordance with an embodiment of the invention.

FIG. 4B is a flow chart illustrating exemplary steps that may be utilized during an M×N IDCT operation based on a minimum number of R MSBs for the transform coefficients in the transform matrix, in accordance with an embodiment of the invention.

FIG. 5 is a flow chart illustrating exemplary steps that may be utilized for codifying signals that ensure high fidelity reconstruction in accordance with an embodiment of the invention.

FIG. 6 is a block diagram illustrating exemplary systems that utilize high fidelity transforms, in accordance with an embodiment of the invention.

### DETAILED DESCRIPTION OF THE INVENTION

Certain embodiments of the invention may be found in a method and system for codifying signals that ensures high fidelity reconstruction. In data coding and decoding systems, specifying a minimum required bit precision for the most significant bits (MSBs) of the transform coefficients in a transform matrix may result in a computationally efficient, high fidelity reconstruction of the signal samples. For example, during a forward transform operation, a number F of MSBs selected from a reference transform coefficient in an effective transform matrix may be utilized to ensure a specified reconstruction accuracy or fidelity. Similarly, during an inverse transform operation, a number R of MSBs selected from a reference transform coefficient in an effective transform matrix may be utilized to ensure a specified reconstruction accuracy or fidelity. The forward transform operation and the inverse transform operation may be, for example, a Discrete Cosine Transform (DCT) and an Inverse Discrete Cosine Transform (IDCT) respectively. The transform coefficients may also comprise least significant bits (LSBs) that differ from corresponding LSBs in the reference transform coefficients without affecting the specified reconstruction accuracy. This approach provides flexibility by allowing system designers to implement coding/decoding systems into a system architecture that best suits operational and cost requirements while at the same time providing high fidelity reconstruction without the need for mismatch error control.

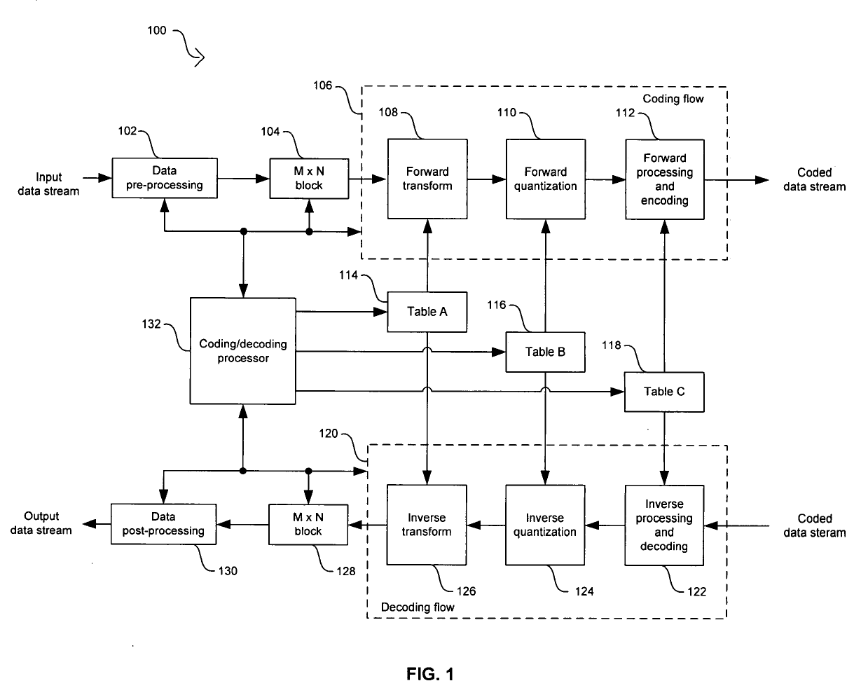

FIG. 1 is a block diagram of a data coding and decoding system that may be utilized in connection with an embodiment of the invention. Referring to FIG. 1, an exemplary data coding and decoding system 100 may comprise a data pre-processing block 102, an M×N block unit 104, a coding flow block 106, a table A 114, a table B 116, a table C 118, a decoding flow block 120, an M×N block unit 128, a data post-processing block 130, and a coding/decoding processor 132. The coding flow block 106 may comprise a forward transform block 108, a forward quantization block 110, and a forward processing and encoding block 112. The decoding flow block 120 may comprise an inverse transform 126, an inverse quantization block 124, and an inverse processing and decoding block 122.

The data pre-processing block 102 and the data post-processing block 128 may comprise suitable logic, circuitry, and/or code and may be adapted to manipulate and/or modify input data and output data respectively. The M×N blocks 104 and 126 may comprise suitable logic, circuitry, and/or code that may be adapted to select M×N arrays of data points from the data stream, where M×N may represent, but is not limited to, for example, 4×4, 8×4, 4×8, and 8×8 arrays of points. For example, the coding/decoding processor 132 may be utilized to indicate to the M×N blocks 104 and 126 which array size to select during operation.

The forward transform block 108 and the inverse transform block 126 may comprise suitable logic, circuitry, and/or code and may be adapted to implement a forward transform operation and an inverse transform operation respectively. The forward transform operation may be, for example, a DCT operation and the inverse transform operation may be, for example, an IDCT operation. The forward transform operation may convert data domain samples into transform domain samples. The inverse transform operation may convert transform domain samples into data domain samples. The table A 114 may comprise suitable logic, circuitry, and/or code that may be adapted to store a plurality of matrix coefficients to be utilized by the forward transform block 108 and/or the inverse transform block 126. In another embodiment, the forward transform block 108 and the inverse transform block 126 may each utilize a separate table of matrix coefficients. The table A 114, or separate tables when separate tables are utilized, may correspond to a portion of a system memory and/or local memory that may be utilized to store a plurality of information that may be utilized by the data coding and decoding system 100.

The forward quantization block 110 and the inverse quantization block 124 may comprise suitable logic, circuitry, and/or code and may be adapted to provide forward quantization and inverse quantization respectively based on the quantization table contained in table B 116. The table B 116 may comprise suitable logic, circuitry, and/or code that may be adapted to store a plurality of matrix coefficients to be utilized by the forward quantization block 110 and/or the inverse quantization block 124. In another embodiment, the forward quantization block 110 and the inverse quantization block 124 may each utilize a separate table of matrix coefficients. The table B 116, or separate tables when separate tables are utilized, may correspond to a portion of a system memory and/or local memory that may be utilized to store a plurality of information that may be utilized by the data coding and decoding system 100.

The forward processing and encoding block 112 and the inverse processing and decoding block 122 may comprise suitable logic, circuitry, and/or code and may be adapted to provide forward processing and encoding and reverse processing and decoding respectively based on the contents in table C 118. The forward encoding and inverse encoding may be, for example, entropy encoding and entropy decoding respectively. The table C 118 may comprise suitable logic, circuitry, and/or code that may be adapted to store a plurality of parameters and/or values to be utilized by the forward processing and encoding block 112 and/or the inverse processing and decoding block 122. In another embodiment, the forward processing and encoding block 112 and the inverse processing and decoding block 122 may each utilize a separate table of matrix coefficients. The table C 118, or separate tables when separate tables are utilized, may correspond to a portion of a system memory and/or local memory that may be utilized to store a plurality of information that may be utilized by the data coding and decoding system 100.

The coding/decoding processor 132 may comprise suitable logic, circuitry, and/or code and may be adapted to update, modify, and control the contents and operation of coding flow block 106, the decoding flow block 120, the data pre-processing block 102, the M×N blocks 104 and 128, the data post-processing block 130, the table A 114, the table B 116, and/or the table C 118.

In some instances, at least a portion of the operations of the data coding and decoding system 100 in FIG. 1 may be performed by at least one processor, wherein the processor may be a central processing unit (CPU) and/or a digital signal processor (DSP), an application specific integrated circuit (ASIC), or a programmable device such as a field programmable gate array (FPGA) or a complex programmable logic device (CPLD). The data coding portion and the data decoding portion of the data coding and decoding system 100 may be performed by separate devices. Some devices may perform both the data coding portion and the data decoding portion while other devices may only perform the data decoding portion. Moreover, separate devices may be located in distinct locations.

In an example of the operation of the data coding and decoding system 100, the M×N blocks 104 and 128 may be 8×8 transform blocks that may be utilized to illustrate various exemplary steps for codifying signals that ensure high fidelity reconstruction. However, other size transforms, for example, 4×4, 8×4 and 4×8, may also be utilized without departing from the various aspects of the method and system for codifying signals that ensure high fidelity reconstruction. When different size transforms are utilized, the specific number of required bits may have to be adjusted accordingly.

In the illustrative example, an inverse transform operation may be a two-dimensional (2D) 8×8 IDCT operation that may be performed in the inverse transform block 126 and may be expressed in matrix form as
[x(m,n)]_{8×8}=T′*[y(i,j)]_{8×8}*T, (1)
where T is an ideal or infinite precision 8×8 transform matrix that may be expressed by

$$T = [ \begin{matrix}a & a & a & a & a & a & a & a \\ b & d & e & g & - g & - e & - d & - b \\ c & f & - f & - c & - c & - f & f & c \\ d & - g & - b & - e & e & b & g & - d \\ a & - a & - a & a & a & - a & - a & a \\ e & - b & g & d & - d & - g & b & - e \\ f & - c & c & - f & - f & c & - c & f \\ g & - e & d & - b & b & - e & - d & - g\end{matrix} ] , \qquad ( 2 )$$

T′ is the transpose of T, [x(m,n)]_{8×8} is an output matrix of the inverse transform operation that comprises data domain samples, [y(i,j)]_{8×8} is an input matrix to the inverse transform operation that comprises transform domain samples, and the transform coefficients for T and T′, which for an IDCT may correspond to a plurality of cosine coefficients, are given as follows:

$$( \begin{matrix}a \\ b \\ c \\ d \\ e \\ f \\ g\end{matrix} ) = \frac{1}{2} ( \begin{matrix}cos ( π / 4 ) \\ cos ( π / 16 ) \\ cos ( π / 8 ) \\ cos ( {3}^{*} π / 16 ) \\ cos ( {5}^{*} π / 16 ) \\ cos ( {3}^{*} π / 8 ) \\ cos ( {7}^{*} π / 16 )\end{matrix} ) . \qquad ( 3 )$$

Because the transform coefficients of the ideal transform matrix, T, have infinite precision, practical systems may require that a finite precision representation of the transform coefficients may be implemented. In many instances, an efficient finite precision implementation of the ideal transform matrix, T, may require a decomposition into a plurality of smaller finite precision transform operations. The overall effect of these smaller finite precision transform operations is to provide an effective transform matrix of finite precision that is representative of the ideal transform matrix, T. The higher the precision, that is, in general, the higher the number of bits in the coefficients of this effective transform matrix, the higher the accuracy or fidelity of the reconstruction provided by the transform operation.

The input matrix [y(i,i)]_{8×8} may comprise transform domain samples of finite precision that may be, for example, 12-bit signed values in the range of −2048 to 2047, inclusive. The output matrix [x(m,n)]_{8×8} may comprise reconstructed data domain samples of finite precision that may be, for example, 9-bit signed values. The output matrix [x(m,n)]_{8×8} and the input matrix [y(i,j)]_{8×8} may each comprise 64 data coefficients. The transform coefficients of the effective transform matrix may be stored in, for example, the table A 114 in FIG. 1 and may be transferred to the decoding flow block 120 to perform the IDCT operation.

In another aspect of the illustrative example, a forward transform operation may be a two-dimensional (2D) 8×8 DCT operation that may be performed in the forward transform block 108 and may be expressed in matrix form as
[y(m,n)]_{8×8}=T*[x(i,j)]_{8×8}*T′, (4)
where T is the same ideal infinite precision transform matrix as described in Equation (2) and T′ is its transpose, [x(i,j)]_{8×8} is an input matrix to the forward transform operation and [y(m,n)]_{8×8} is an output matrix of the forward transform operation. The input matrix [x(i,j)]_{8×8} may comprise data domain samples of finite precision that may be, for example, 9-bit signed values. The output matrix [y(m,n)]_{8×8} may comprise transform domain samples of finite precision that may be, for example, 12-bit signed values in the range of −2048 to 2047, inclusive. The output matrix [y(m,n)]_{8×8} and the input matrix [x(i,j)]_{8×8} may each comprise 64 data coefficients. As with the IDCT implementation, the ideal transform matrix T may be implemented as an effective transform matrix of finite precision for practical DCT applications.

Referring to the inverse transform operation described in Equation (1), the input and output matrices may be expressed as Y=[y(i,j)]_{8×8} and X=[x(i,j)]_{8×8}. In the exemplary embodiment illustrated in FIG. 1, the transform domain samples in Y may correspond to the output samples from the forward transform block 108. Likewise, assuming error-free quantization, encoding, decoding, and inverse quantization operations, the transform domain samples in Y may also correspond to the output of the inverse quantization block 124.

In some instances, to provide compatibility between various finite precision implementations, it may be necessary to specify the accuracy of the finite precision coefficients in the effective transform matrix in terms of a minimum number of most significant bits (MSBs) from the ideal transform matrix coefficients in order to provide a specified reconstruction accuracy and fidelity. This approach may overcome the rigidity of integer transforms and the inaccuracies of statistical transform definitions. In this regard, there is a need to determine the minimum finite precision that provides high fidelity reconstruction without the need for mismatch error control. Each of the transform coefficients in the effective transform matrix may comprise Q most significant bits (MSBs) of the corresponding reference coefficient values and a residue value, where the residue value corresponds to the bits not selected. Alternatively, each of the reference transform coefficients in the effective transform matrix may comprise a value equivalent to the sum of the corresponding reference coefficient value, an offset value, and a set of less significant bits, such that the sum of the offset value and the less significant bits may be either positive or negative polarity and its magnitude may be bounded by the design constraints of the system. The sum of the offset value and the less significant bits corresponds to the residue associated with that coefficient value. The offset value may be, for example, a negative value whose magnitude is equivalent to the value of a ‘1’ bit in the place of the least significant of the Q MSBs. The transform coefficients in the ideal transform matrix may be referred to as reference transform coefficients because the finite precision transform coefficients generally need to approximate the values of the corresponding reference coefficients for high fidelity reconstruction. In some applications, the number of Q-bits that may be selected or predetermined from each reference transform coefficient may be distinct for each reference transform coefficient. The finite precision effective transform matrix may be expressed as T=T₀+Δ, where T₀ is a finite precision 8×8 transform matrix comprising Q MSBs selected for each of the corresponding reference transform coefficients, Δ(i,j) is an 8×8 residue matrix, and the reconstructed data domain samples generated utilizing To may be given as X₀=T′₀YT₀. The transform matrix, T₀, may be utilized to determine the reconstructed data domain samples as follows:

$$\begin{matrix}X = {T}^{′} Y T = {( {T}_{0} + Δ )}^{′} Y ( {T}_{0} + Δ ) \\ = {T}_{0}^{′} Y {T}_{0} + {T}_{0}^{′} Y Δ + {Δ}^{′} Y {T}_{0} + {Δ}^{′} Y Δ\end{matrix} \qquad ( 5 )$$

where T₀′ is the transpose of T₀ and Δ is the residue matrix. The 8×8 difference matrix (X−X₀)=T′₀YΔ+Δ′YT₀+Δ′YΔ. Then the Q MSBs may be determined by applying the constraint

$$max \vert X ( i , j ) - {X}_{0} ( i , j ) \vert < \frac{1}{2} , for i , j = 0 , … , 7 , or \\ max \vert {T}_{0}^{′} Y Δ + {Δ}^{′} Y {T}_{0} + {Δ}^{′} Y Δ \vert < \frac{1}{2} , for i , j = 0 , … , 7 , \qquad ( 6 )$$

where ½ is a rounding error, X(i,j) comprises finite precision reconstructed data domain samples that result when utilizing the finite precision effective transform matrix, and X₀(i,j) comprises finite precision reconstructed data domain samples that result when utilizing the finite precision transform matrix, T₀. The rounding error may vary according to the degree of error that may be utilized in a particular application. For example, in some instances the threshold level may be 1 when a higher degree of error may be tolerated in the system and/or design.

The maximum value of Equation (6) may be obtained when the elements of matrix Y comprise appropriate values and signs. By matrix multiplication Equation (6) may be rewritten as

$$16 ( 2 a + b + c + d + e + f + g ) {Δ}_{max} {\vert Y \vert}_{max} + 64 {Δ}_{max}^{2} {\vert Y \vert}_{max} < \frac{1}{2} \qquad ( 7 )$$

where Δₘₐₓ=max|Δ(i,j)| and |Y|ₘₐₓ=max|[y(i,j)]_{8×8}|. By constraining Δₘₐₓ< 1/32, then the relationship in Equation (7) is guaranteed when
[16(2a+b+c+d+e+f+g)+2]max|Δ(i,j)|<1/(2|Y|ₘₐₓ) (8)
where Equation (8) may also be rewritten as

$$max \vert Δ ( i , j ) \vert < \frac{1}{{2}^{7}} \cdot \frac{1}{{\vert Y \vert}_{max}} , for i , j = 0 , … , 7. \qquad ( 9 )$$

The constraint on Δₘₐₓ may be selected in accordance with the application. When utilizing 12-bit signed values for the transform domain samples, Equation (9) may be expressed as

$$max \vert Δ ( i , j ) \vert < \frac{1}{{2}^{7}} \cdot \frac{1}{{2}^{11}} , for i , j = 0 , … , 7 , or \\ max \vert Δ ( i , j ) \vert < \frac{1}{{2}^{18}} , for i , j = 0 , … , 7. \qquad ( 10 )$$

In this regard, Equation (10) may guarantee the condition shown in Equation (6) for 12-bit signed values for the transform domain data samples. The condition of Equation (10) may be achieved in various ways. For example, each transform coefficient T₀(i,j) may comprise the 18 MSBs of the corresponding reference coefficient T(i,j). Alternatively, each of T₀(i,j) may comprise the 18 MSBs of T(i,j) and may also comprise less significant bits of arbitrary value. Alternatively, each of the T₀(i,j) may comprise the sum of T(i,j) plus a difference value, where the difference value may have either positive or negative polarity and the magnitude of the difference is bounded to ½¹⁸, in which case the value of T₀(i,j,) may be less than the value comprised of the 18 MSBs of T(i,j). The value of T₀(i,j) may comprise the sum of the 18 MSBs of T(i,j) minus an offset plus less significant bits of arbitrary value, where the offset is equivalent to a ‘1’ bit at the least significant bit position of the 18 MSBs.

Accordingly, the implementation of the IDCT operation in, for example, the inverse transform block 126 may be able to achieve high fidelity reconstruction when the transform coefficients are expressed as at least 18 MSB s as indicated by the exponent of the denominator on the right hand side of Equation (10). For example, when 13-bit signed values are utilized, the exponent in Equation (10) may be 19 indicating that 19 MSB s may be needed for high fidelity reconstruction. Similarly, when 11-bit signed values are utilized, the exponent in Equation (10) may be 17 indicating that 17 MSBs may be needed for high fidelity reconstruction. When a different rounding error is selected in Equation (6), the number of Q MSBs that provide reconstruction fidelity as shown by the exponent in Equation (10) may be different. For example, when the rounding error is 1 in Equation (6), the exponent in Equation (10) may be 17 indicating that 17 MSBs may be needed to provide high fidelity reconstruction for the 12-bit transform domain samples. A similar analysis may be performed in the case of a forward transform operation. For example, for the DCT operation on 9-bit signed data domain samples, the exponent in Equation (10) may be 15 indicating that 15 MSBs may be needed to provide high fidelity reconstruction when the specified reconstruction accuracy or rounding error is ½. The various ways of achieving the condition of Equation (10) may be utilized when the exponent in Equation (10) differs from 18, substituting the appropriate value in the description above.

The determination of the number of MSBs that ensure high fidelity reconstruction for forward and/or for inverse transform operations may not be limited to the exemplary IDCT and DCT operations described herein. The approach described may also be applicable when the transform coefficients, the transform size, the number of bits in the data domain samples and/or in the transform domain samples, the rounding error, and/or the constraint on Δₘₐₓ differ from those utilized in the exemplary IDCT and DCT operations.

For an inverse transform operation, the minimum number of Q MSBs that may provide high fidelity reconstruction without the need for mismatch error control may be referred to as R MSBs. In the case of a forward transform operation, the minimum Q MSBs needed may be referred to as F MSBs. In this regard, the R MSBs may be selected from Pr bits of precision in the reference transform coefficients of the effective transform matrix. The F MSBs may be selected from Pf bits of precision in the reference transform coefficients of the effective transform matrix. In some instances, the number of Pr bits of precision and the number of Pf bits of precision may be the same.

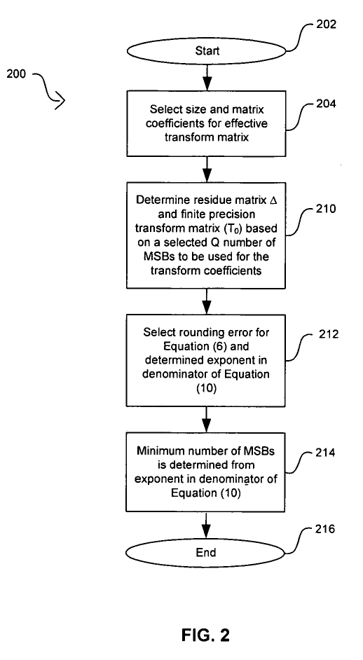

FIG. 2 is a flow chart illustrating exemplary steps for determining a minimum number of most significant bits to be selected from a reference transform coefficient in an effective transform matrix, in accordance with an embodiment of the invention. Referring to FIG. 2, after start step 202, the size and matrix coefficients for an effective transform matrix may be selected based on the coding and/or decoding operations to be performed in step 204. In step 210, the finite precision transform matrix To and the residue matrix Δ may be determined by selecting Q MSBs from the reference transform coefficients in the effective transform matrix. For a forward transform operation, the minimum Q MSBs may be F MSBs out of Pf finite precision bits. For an inverse transform operation the minimum Q MSBs may be R MSBs out of Pr finite precision bits. In step 212, the rounding error in Equation (6) may be selected and Equation (6) may be utilized to determine the exponent in the denominator of Equation (10). In step 214, the F MSBs or the R MSBs may be determined from the exponent in the right hand side of Equation (10). After step 214, the flow diagram 200 may proceed to end step 216.

Determination of the F or R MSBs for ensuring high fidelity reconstruction without the need for mismatch error control in forward transform operations or inverse transform operations may be based on a deterministic approach as described in FIG. 2. Moreover, the approach may be also extended to the case where the minimum number of Q MSBs selected from each reference transform coefficient may be different.

In another aspect of the invention, the transform matrix To with finite precision may be expressed as

$${T}_{0} = [ \begin{matrix}{a}_{0} & {a}_{0} & {a}_{0} & {a}_{0} & {a}_{0} & {a}_{0} & {a}_{0} & {a}_{0} \\ {b}_{0} & {d}_{0} & {e}_{0} & {g}_{0} & - {g}_{0} & - {e}_{0} & - {d}_{0} & - {b}_{0} \\ {c}_{0} & {f}_{0} & - {f}_{0} & - {c}_{0} & - {c}_{0} & - {f}_{0} & {f}_{0} & {c}_{0} \\ {d}_{0} & - {g}_{0} & - {b}_{0} & - {e}_{0} & {e}_{0} & {b}_{0} & {g}_{0} & - {d}_{0} \\ {a}_{0} & - {a}_{0} & - {a}_{0} & {a}_{0} & {a}_{0} & - {a}_{0} & - {a}_{0} & {a}_{0} \\ {e}_{0} & - {b}_{0} & {g}_{0} & {d}_{0} & - {d}_{0} & - {g}_{0} & {a}_{0} & - {e}_{0} \\ {f}_{0} & - {c}_{0} & {c}_{0} & - {f}_{0} & - {f}_{0} & {c}_{0} & - {c}_{0} & {f}_{0} \\ {g}_{0} & - {e}_{0} & {d}_{0} & - {b}_{0} & {b}_{0} & - {e}_{0} & - {d}_{0} & - {g}_{0}\end{matrix} ] . \qquad ( 11 )$$

where the transform coefficients a₀, . . . , g₀ may comprise, for example, the 18 MSBs (R=18) of the reference transform coefficients in the effective transform matrix for an inverse transform operation with 12-bit signed value transform domain samples and a rounding error of ½. At least one LSB that differs from a corresponding LSB in the reference transform coefficient may be added to the 18 MSBs. Similarly, the transform coefficients a₀, . . . , g₀ may comprise, for example, the 15 MSBs (F=15) of the reference transform coefficients in the effective transform matrix for a forward transform operation with 9-bit signed value data domain samples and a rounding error of ½. At least one LSB that differs from a corresponding LSB in the reference transform coefficient may be added to the 15 MSBs.

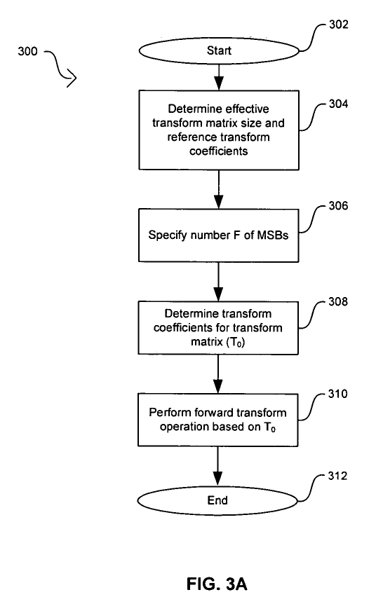

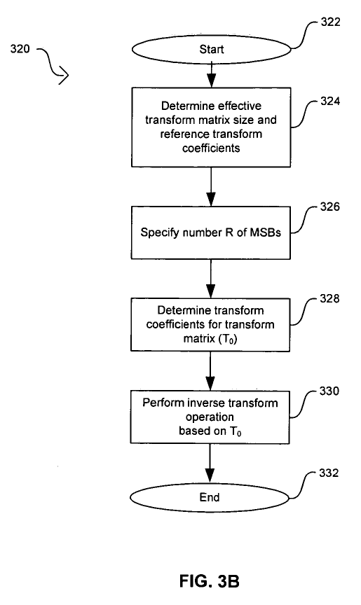

FIG. 3A is a flow chart illustrating exemplary steps that may be utilized to perform forward transform operations based on a minimum number of F MSBs for the transform coefficients in the transform matrix, in accordance with an embodiment of the invention. Referring to FIG. 3A, after start step 302, the reference transform coefficients and the size of the effective transform matrix may be determined based on the application in step 304. For example, at least one dimension of the effective transform matrix may be four points or eight points. In step 306, the minimum number of F MSBs may be specified for the application. In this regard, the F MSBs may be determined prior to performing the forward transform operation. In step 308, the appropriate transform coefficients for the transform matrix T₀ may be generated based on the F MSBs predetermined from the reference transform coefficients. In some instances, the transform coefficients may also comprise at least one least LSB that differs from a corresponding LSB in the reference transform coefficient. In step 310, the forward transform operation may be performed on data domain samples based on the transform matrix T₀. After the forward transform operation is completed, the flow diagram 300 may proceed to end step 312.

FIG. 3B is a flow chart illustrating exemplary steps that may be utilized to perform inverse transform operations based on a minimum number of R MSBs for the transform coefficients in the transform matrix, in accordance with an embodiment of the invention. Referring to FIG. 3B, after start step 322, the reference transform coefficients and the size of the effective transform matrix may be determined based on the application in step 324. For example, at least one dimension of the effective transform matrix may be four points or eight points. In step 326, the minimum number of MSBs may be specified for the application. In this regard, the R MSBs may be determined prior to performing the inverse transform operation. In step 328, the appropriate transform coefficients for the transform matrix T₀ may be generated based on the R MSBs. In some instances, the transform coefficients may also comprise at least one least LSB that differs from a corresponding LSB in the reference transform coefficient. In step 330, the inverse transform operation may be performed on transform domain samples based on the transform matrix T₀. After the inverse transform operation is completed, the flow diagram 320 may proceed to end step 332.

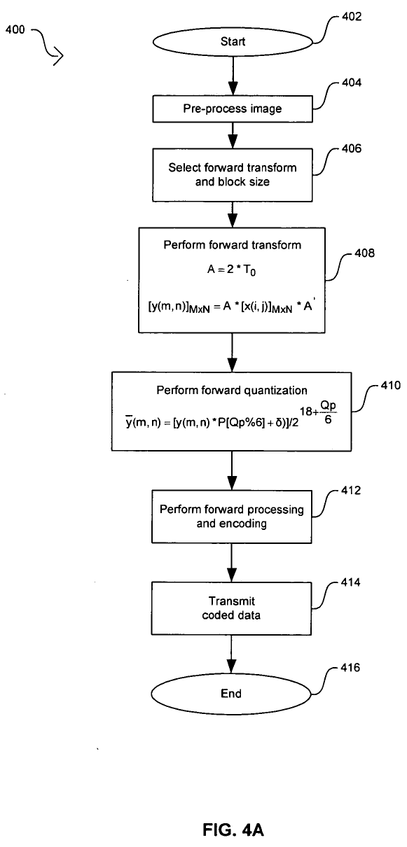

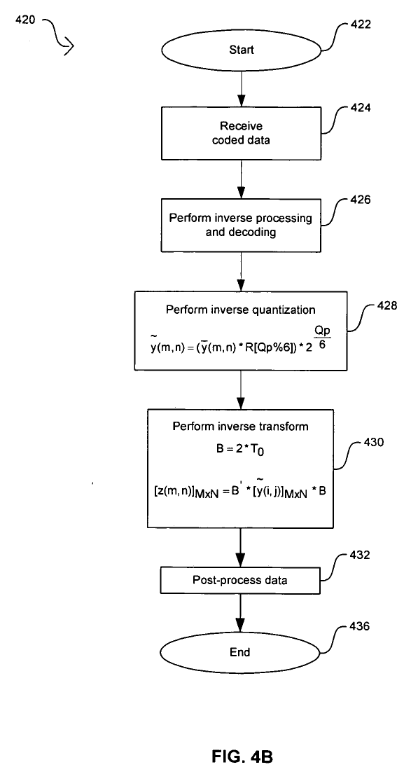

FIG. 4A is a flow chart illustrating exemplary steps that may be utilized during an M×N DCT operation based on a minimum number of F MSBs for the transform coefficients in the transform matrix, in accordance with an embodiment of the invention. Referring to FIG. 4A, after start step 402, in step 404, a coding flow 400 in an illustrative DCT operation may begin by pre-processing the input data from the data stream as shown in FIG. 1. After pre-processing, an M×N block size and the transform coefficients for an M×N transform matrix may be selected in step 406. In step 408, the forward transform operation, in this case the DCT operation, may be applied to the blocks of pre-processed input data or data domain samples. To simplify the forward quantization operation in step 410, the M×N transform matrix in step 408 may be defined as:
A=2*T₀ (12)
where a₀, b₀, . . . and g₀ in T₀ comprise at least the F MSBs of the reference transform coefficients a, b . . . and g. After performing the scaling operation in Equation (12), the transform coefficients of A may have at least the same bit width as in T₀. The scaling operation of T₀ as shown in Equation (12) may vary with system design and may, in some instances, not be required. The DCT operation in step 408 may be defined as
[y(m,n)]_{M×N}=A *[x(i,j)]_{M×N}*A′, (13)
where A′ is the transpose of A, [x(i,j)]_{M×N} is an input matrix to the DCT operation comprising data domain samples and [y(m,n)]_{M×N} is an output matrix of the DCT operation comprising transform domain samples.

Following the DCT operation in step 408, a forward quantization operation is applied in step 410 to the transform domain samples of the output matrix [y(m,n)]_{M×N}. For example, the forward quantization operation in step 410 may be performed as follows:

$$\overline{y} ( m , n ) = [ y {( m , n )}^{*} P [ Q p \% 6 ] + δ ) ] / {2}^{18 + \frac{Q p}{6}} , m , n = 0 , 1 , … 7. \qquad ( 14 )$$

where Qp in Equation (14) is a forward quantization parameter and the value of Qp may range from 0 to 54, inclusive. For example, P[0. . . 5]=[65536, 58254, 52429, 45590, 41943, 36158], and

$$δ = {2}^{17 + \frac{Q p}{6}} .$$

\overline{y}(m,n) may be in the range of −2048 to 2047, inclusive. The forward quantization operation may be flexible. For example, the forward quantization operation may be also be performed as follows

$$\overline{y} ( m , n ) = [ y ( m , n ) * P [ Qp \% 6 ] + δ ) ] / {2}^{15 + \frac{Qp}{6}} , \\ m , n = 0 , 1 , … 7. \qquad ( 15 )$$

where Qp in Equation (15) is a forward quantization parameter and the value of Qp may range from 0 to 54, inclusive. For example, P[0 . . . 5]=[8192, 7282, 6554, 5699, 5243, 4520], and

$$δ = {2}^{14 + \frac{Qp}{6}} .$$

The forward quantization parameters utilized in Equation (14) or in Equation (15) may be stored, for example, in the table B 116 in FIG. 1 and may be transferred to the forward quantization block 110 during operation.

Following the forward quantization operation, forward processing and encoding operations may be applied to the quantized and transformed input data in step 412. Once the forward processing and encoding are completed, the coded data may be transmitted in step 414.

FIG. 4B is a flow chart illustrating exemplary steps that may be utilized during an M×N IDCT operation based on a minimum number of R MSBs for the transform coefficients in the transform matrix, in accordance with an embodiment of the invention. Referring to FIG. 4B, after start step 422, the decoding flow 420 may begin by receiving the coded data in step 424. Reverse processing and decoding operations may be applied to the coded data in step 426. In step 428, an inverse quantization operation may be applied to the output data from step 426. For example, the inverse quantization operation in step 428 may be performed as follows:

$$\tilde{y} ( m , n ) = ( \overline{y} ( m , n ) * R [ Qp \% 6 ] ) * {2}^{\frac{Qp}{6}} , m , n = 0 , 1 , … 7. \qquad ( 16 )$$

where Qp is the inverse quantization parameter and the value of Qp may range from 0 to 54, inclusive. For example, R[0 . . . 5]=[16, 18, 20, 23, 25, 29].

Following the inverse quantization operation in step 428, an IDCT operation may be applied to the inverse quantized image data in step 430. The illustrative M×N transform matrix in step 430 may be defined as
B=2*T₀, (17)
where a₀, b₀, . . . and g₀ in T₀ comprise at least the R MSBs of the reference transform coefficients a, b . . . and g. The elements of B may have at least the same bit width as in T₀. The scaling operation of T₀ shown in Equation (17) may vary with system design and may, in some instances, not be required.

The inverse transform operation, in this case the IDCT operation, in step 430 may be defined as
[z(m,n)]_{M×N}=B′*[\tilde{Y}(i,j)]_{M×N}*B (18)
The final inverse transformation results may be obtained, for example, by scaling as
x(m,n)=[z(m,n)+8)]>>4,m,n=0, 1, . . . 7, (19)
where x(m,n) is the output matrix of the IDCT operation and comprises reconstructed data domain samples. A post-processing of the image data in step 432 may follow step 430. After post-processing, the flow diagram 420 may proceed to end step 436.

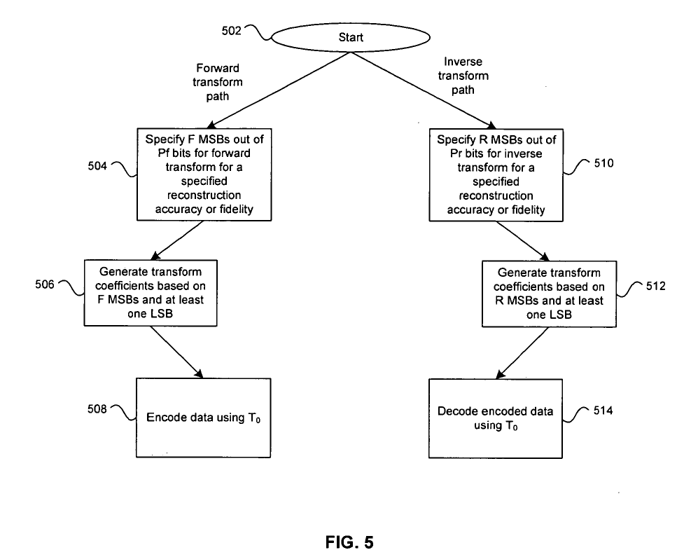

FIG. 5 is a flow chart illustrating exemplary steps that may be utilized for codifying signals that ensure high fidelity reconstruction in accordance with an embodiment of the invention. Referring to FIG. 5, after start step 502, a forward transform path or an inverse transform path are shown. In the forward transform path, in step 504, the F MSBs out of Pf bits of precision in the reference transform coefficients are specified for the forward transform operation. The specification may be based on the precision of the data domain and transform domain samples and on the accuracy provided by the rounding error as substantially described by the approach presented in Equation (6) through Equation (10). In some implementations, the predetermined number of F MSBs may be different for each of the transform coefficients. In step 506, the transform coefficients to be utilized in the finite precision transform matrix T₀ may be determined based on the predetermined F MSBs and on at least on LSB appended to the F MSBs. In step 508, the data may be encoded in, for example, a portion of the data coding and decoding system 100 in FIG. 1 by utilizing the transform matrix T₀.

In the inverse transform path, in step 510, the R MSBs out of Pr bits of precision in the reference transform coefficients are specified for the inverse transform operation. The specification may be based on the precision of the data domain and transform domain samples and on the accuracy provided by the rounding error as substantially described by the approach presented in Equation (6) through Equation (10). In some implementation, the predetermined number of R MSBs may be different for each of the transform coefficients. In step 512, the transform coefficients to be utilized in the finite precision transform matrix may be determined based on the predetermined R MSBs and on at least on LSB appended to the R MSBs. In step 514, the data may be decoded in, for example, a portion of the data coding and decoding system 100 in FIG. 1 by utilizing the transform matrix T₀.

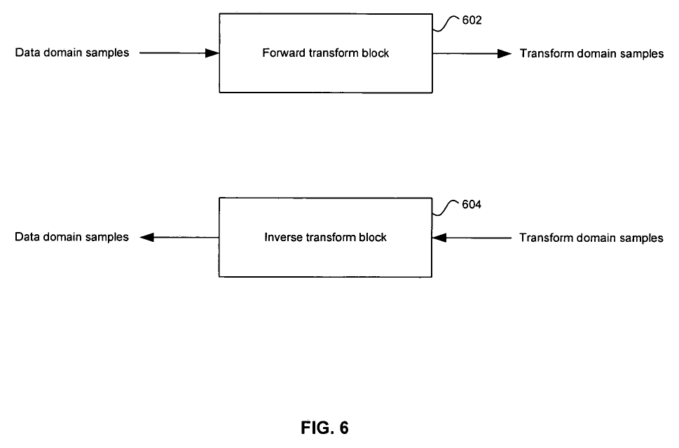

FIG. 6 is a block diagram illustrating exemplary systems that utilize high fidelity transforms, in accordance with an embodiment of the invention. Referring to FIG. 6, there is shown a forward transform block 602 and an inverse transform block 604. The forward transform block 602 and the inverse transform block 604 may be implemented in the same device or may be implemented in separate devices. The forward transform block 602 may comprise suitable logic, circuitry, and/or code that may be adapted to process data domain samples and to generate transform domain samples by utilizing a transform matrix with transform coefficients whose effective values comprise a predetermined number of F MSBs. The forward transform block 602 may also be adapted to operate with at least one LSB appended to the predetermined number of F MSBs. In this regard, the appended LSBs may differ from corresponding LSBs in the reference transform coefficient from which the predetermined number of F MSBs were selected. The effective value of the transform coefficients comprising the predetermined number of F MSBs and the appended LSBs provides a specified reconstruction accuracy or fidelity that may not require mismatch error control.

The inverse transform block 604 may comprise suitable logic, circuitry, and/or code that may be adapted to process transform domain samples and to generate data domain samples by utilizing a transform matrix with transform coefficients whose effective values comprise a predetermined number of R MSBs. The inverse transform block 604 may also be adapted to operate with least one LSB appended to the predetermined number of R MSBs. In this regard, the appended LSBs may differ from corresponding LSBs in the reference transform coefficient from which the predetermined number of R MSBs were selected. The effective value of the transform coefficients comprising the predetermined number of R MSBs and the appended LSBs provides a specified reconstruction accuracy or fidelity that may not require mismatch error control.

The approach described herein provides flexibility by allowing system designers to implement coding/decoding systems into a system architecture that best suits operational and cost requirements while at the same time providing high fidelity reconstruction without the need for mismatch error control.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A method for signal processing, the method comprising:
receiving a plurality of transform domain samples; and
generating a plurality of data domain samples by performing a two-dimensional (2D) transform of said received plurality of transform domain samples based on a transform matrix, wherein an effective value of each transform coefficient of said transform matrix comprises a predetermined number R of most significant bits (MSBs) of a corresponding reference transform and at least one appended least significant bit (LSB), said 2D transform provides a specified reconstruction accuracy of said received plurality of transform domain samples.

2. The method according to claim 1, wherein at least one of said at least one appended LSB differs from a corresponding LSB in said corresponding reference transform coefficient.

3. The method according to claim 1, wherein said 2D transform is an inverse discrete cosine transform (IDCT).

4. The method according to claim 1, wherein at least one dimension of said transform matrix comprises four points.

5. The method according to claim 1, wherein at least one dimension of said transform matrix comprises eight points.

6. The method according to claim 1, wherein said effective value of each transform coefficient of said transform matrix comprises the sum of an offset value with said predetermined number R of MSBs of said corresponding reference transform and said at least one appended LSB.

7. A method for signal processing, the method comprising:
receiving a plurality of data domain samples; and
generating a plurality of transform domain samples by performing a two-dimensional (2D) transform of said received plurality of data domain samples based on a transform matrix, wherein an effective value of each transform coefficient of said transform matrix comprises a predetermined number F of most significant bits (MSBs) of a corresponding reference transform coefficient and at least one appended least significant bit (LSB), said 2D transform provides a specified reconstruction accuracy of said received plurality of data domain samples.

8. The method according to claim 7, wherein at least one of said at least one appended LSB differs from a corresponding LSB in said corresponding reference transform coefficient.

9. The method according to claim 7, wherein said 2D transform is a discrete cosine transform (DCT).

10. The method according to claim 7, wherein at least one dimension of said transform matrix comprises four points.

11. The method according to claim 7, wherein at least one dimension of said transform matrix comprises eight points.

12. A machine-readable storage having stored thereon, a computer program having at least one code section for signal processing, the at least one code section being executable by a machine for causing the machine to perform steps comprising:
receiving a plurality of transform domain samples; and
generating a plurality of data domain samples by performing a two-dimensional (2D) transform of said received plurality of transform domain samples based on a transform matrix, wherein an effective value of each transform coefficient of said transform matrix comprises a predetermined number R of most significant bits (MSBs) of a corresponding reference transform coefficient and at least one appended least significant bit (LSB), said 2D transform provides a specified reconstruction accuracy of said received plurality of transform domain samples.

13. The machine-readable storage according to claim 12, wherein at least one of said at least one appended LSB differs from a corresponding LSB in said corresponding reference transform coefficient.

14. The machine-readable storage according to claim 12, wherein said predetermined number R of MSBs comprises an offset.

15. The machine-readable storage according to claim 12, wherein said 2D transform is an inverse discrete cosine transform (IDCT).

16. The machine-readable storage according to claim 12, wherein at least one dimension of said transform matrix comprises four points.

17. The machine-readable storage according to claim 12, wherein at least one dimension of said transform matrix comprises eight points.

18. A system for signal processing, the system comprising:
circuitry that receives a plurality of transform domain samples; and
circuitry that generates a plurality of data domain samples by performing a two-dimensional (2D) transform of said received plurality of transform domain samples based on a transform matrix, wherein an effective value of each transform coefficient of said transform matrix comprises a predetermined number R of most significant bits (MSBs) of a corresponding reference transform coefficient and at least one appended least significant bit (LSB), said 2D transform provides a specified reconstruction accuracy of said received plurality of transform domain samples.

19. The system according to claim 18, wherein at least one of said at least one appended LSB differs from a corresponding LSB in said corresponding reference transform coefficient.

20. The system according to claim 18, wherein said predetermined number R of MSBs comprises an offset.
